(19) United States
(12) Patent Application Publication
(10) Pub. No.: US 2008/0084828 A1
(43) Pub. Date: Apr. 10, 2008

(54) SYSTEM AND METHOD FOR DYNAMICALLY ADDING AND DELETING ETHERNET ADAPTERS

(75) Inventors: Ron E. Gonzalez, Austin, TX (US); Binh K. Hua, Austin, TX (US); Sivarama K. Kodukula, Round Rock, TX (US); Rakesh Sharma, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/539,656

(22) Filed: Oct. 9, 2006

(51) Int. Cl. H04J 1/16

(52) U.S. Cl. 370/252; 370/465

(57) ABSTRACT

A method to dynamically adjust the number of active Ethernet adapters in a EtherChannel group, the method including: monitoring a total EtherChannel throughput; determining availability of unused Ethernet adapters if the throughput is above a first predetermined throughput; powering up and adding an unused Ethernet adapter to the EtherChannel group if the throughput is above the first predetermined throughput; powering down and removing an active Ethernet adapter from the EtherChannel group if the throughput is less than the second predetermined throughput; and continue monitoring the total EtherChannel throughput after sleeping for a selected period of time. Accordingly, when an adapter is removed from the EtherChannel group, power to the removed adapter is cut off to reduce power consumption and reduce generation of thermal heat, thus increasing a potential lifespan of the plurality of adapters.

### TRADEMARKS

IBM ® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a system and method for dynamically adding and deleting Ethernet adapters, and particularly to, dynamically adding and deleting Ethernet adapters to and from an EtherChannel group based on a network workload.

2. Description of Background

Networking demands are increasing faster than the current network devices can handle. Bandwidth hungry applications, such as online content, e-commerce, large databases and streaming media, require more network bandwidth than conventional textual data. Today, the most popular one-gigabit (1-Gbit) Ethernet network speed adapter does not meet the network bandwidth demands in some of these environments. Referring to the high level EtherChannel software interface 100 of FIG. 1, the EtherChannel and IEEE 802.3ad technologies have been developed to address these business needs by grouping multiple network adapters 102 together to form a single larger pipeline or EtherChannel group 104 to increase bandwidth. The EtherChannel interface (consisting multiple Ethernet interfaces, as shown in FIG. 1 with 4 interfaces) is treated as a single interface, which is called a “port channel”. Link aggregation, or IEEE 802.3ad, is a computer networking standard which describes using multiple Ethernet network cables/ports in parallel to increase the link speed beyond the limits of any one single cable or port. Other terms for this include “Ethernet trunk”, “NIC teaming”, “port teaming”, “port trunking”, “EtherChannel”, “NIC bonding”, and “link aggregate group” (LAG). Most implementations now conform to clause 43 of IEEE 802.3 standard, informally referred to as “802.3ad”.

For example, four 1-Gbit Ethernet adapters can be combined in a server to create a single 4-Gbit network interface using one IP address. Currently, 10-gigabit network equipment is becoming available but remains comparatively expensive. With trunking four 1 Gb interfaces, a network backbone can be established with a speed of up to 4-gigabits/second while using the much more common 1-gigabit switches.

To be an efficient system administration/planner, he or she must plan to have enough network adapters to handle the peak network bandwidth. This creates unnecessary active adapters in the EtherChannel group at non-peak times, which unnecessarily consumes electrical power and increases the thermal heat of the system. It is very difficult for the system administrator to manually adjust (e.g., add or delete) the number of network adapters in the EtherChannel group based on the system network workload at specific times.

Today, a high end server can support more than 100 I/O adapters. High speed adapters such as the 10-Gbit Ethernet adapter consume more than 20 Watts per adapter. Therefore, a system and method is desired that can save power by dynamically adjusting the number of adapters the system needs to support the network workload at specific times.

### SUMMARY OF THE INVENTION

The shortcomings of the prior art are overcome and additional advantages are provided through the provision of a method to dynamically adjust the number of active Ethernet adapters in a EtherChannel group. In an exemplary embodiment, the method includes: monitoring a total EtherChannel throughput; determining availability of unused Ethernet adapters if the throughput is above a first predetermined throughput; powering up and adding an unused Ethernet adapter to the EtherChannel group if the throughput is above the first predetermined throughput; powering down and removing an active Ethernet adapter from the EtherChannel group if the throughput is less than the second predetermined throughput; and continue monitoring the total EtherChannel throughput after sleeping for a selected period of time.

In another exemplary embodiment, a method to dynamically adjust the number of active Ethernet adapters in a EtherChannel group includes: monitoring a total EtherChannel throughput; determining availability of unused Ethernet adapters if the throughput is greater than 80% of a current maximum EtherChannel throughput; powering up and adding an unused Ethernet adapter to the EtherChannel group if the throughput is greater than 80% of the current maximum EtherChannel throughput; sending a LAN management frame to activate a switch port of the added adapter; powering down and removing an active Ethernet adapter from the EtherChannel group if the throughput is less than 50% of a current maximum EtherChannel throughput; sending a LAN management frame to put the switch port of the removed adapter into sleep mode; and continue monitoring the total EtherChannel throughput after sleeping for a selected period of time.

In yet another exemplary embodiment, a system for dynamically adjusting the number of active Ethernet adapters based on a network workload is disclosed. The system includes: a EtherChannel group having a plurality of Ethernet drivers each associated with a corresponding Ethernet adapter; and a network throughput monitor which tracks throughput of transmission (Tx) and reception (Rx) of the EtherChannel group including a Tx count register and Rx count register, respectively, associated with each corresponding Ethernet driver, wherein the network monitor is adapted to add or delete an active Ethernet adapter from the EtherChannel group based on a current network workload.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which offers a method which dynamically adjusts the number of adapters in an EtherChannel group based on the network workload. When the adapter is no longer in the EtherChannel group, the system and method cut off power to the adapter not needed in the EtherChannel group to reduce overall power consumption and reduce the thermal heat generated by the group, which in turn increases a lifespan of the adapters in the group.

### BRIEF DESCRIPTION OF THE DRAWINGS

The subject matter which is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a block diagram illustrating a prior art example of grouping a plurality of network adapters together to form a larger single pipeline;

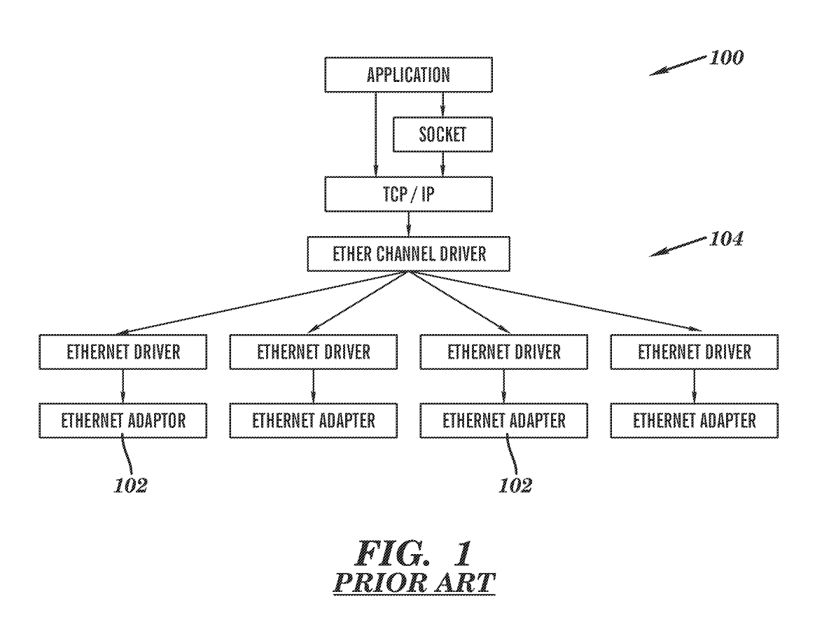

FIG. 2 is a block diagram illustrating grouping a plurality of network adapters together as in FIG. 1 with the addition of exemplary logic to monitor network throughput for determining whether to dynamically add or delete a network adapter relative to the plurality of network adapters in accordance with an exemplary embodiment of the present invention; and

FIG. 3 is a flow chart illustrating an exemplary method to monitor the network throughput and dynamically add or delete a network adapter relative to the plurality of network adapters in accordance with an exemplary embodiment of the present invention.

The detailed description explains exemplary embodiments of the invention, together with aspects, features and advantages, by way of example with reference to the drawings.

### DETAILED DESCRIPTION OF THE INVENTION

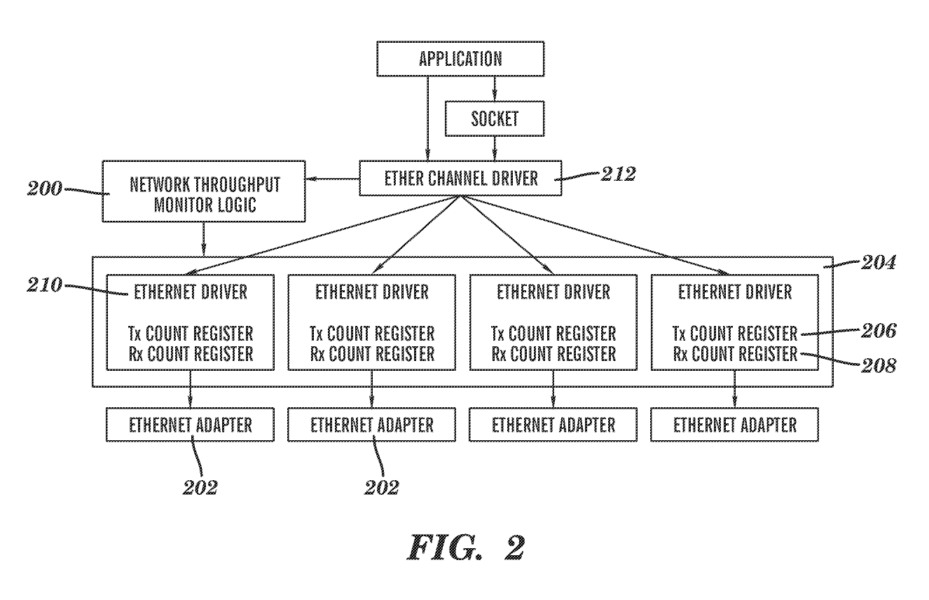

Turning now to the drawings in greater detail, it will be seen that this invention proposes to add new logic in a network throughput monitor 200 to keep track of the throughput of transmission (Tx) and reception (Rx) of the EtherChannel via a Tx count register 206 and Rx count register 208 associated with each corresponding Ethernet driver 210, as shown in FIG. 2. The new logic monitors the network throughput to determine whether or not to add or delete an adapter as needed.

When the throughput monitor logic in monitor 200 determines that the throughput of the EtherChannel group has dropped significantly, it reduces the number of Ethernet adapters 202 in the EtherChannel group 204. Accordingly, the electrical power that would be used to power an unused adapter 202 can be saved to decrease power consumption and thus reduce heat generated therefrom and increase a potential lifespan of the plurality of adapters 202 associated with the EtherChannel group 204.

As the throughput of the EtherChannel group 204 approaches a maximum capability of the current EtherChannel group 204, it powers on the unused adapters and adds them to the group to increase a maximum throughput and to avoid network overload. It will be recognized by those skilled in the pertinent art that although the network throughput monitor logic is associated with the network throughput monitor 200 depicted as a separate device, it may be incorporated with another device in the network, for example, but is not limited thereto.

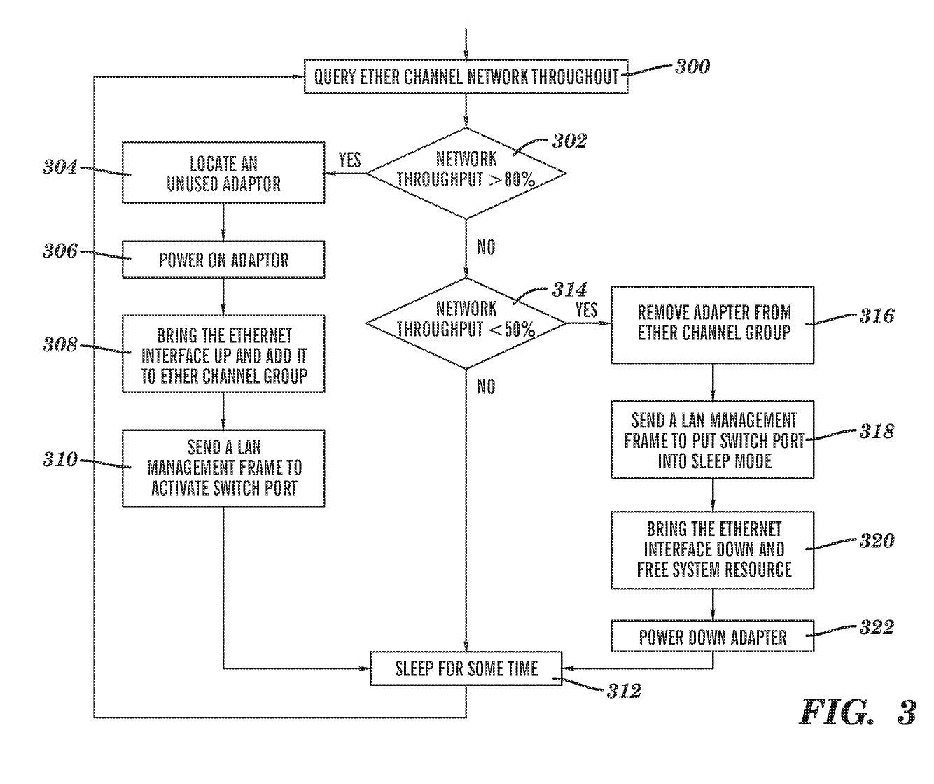

Referring to FIG. 3, an exemplary method to dynamically adjust the number of active Ethernet adapters in an EtherChannel group will be described below. FIG. 3 is a flowchart of the exemplary method illustrating the network throughput monitor logic. At block 300, the total Ethernet Channel network throughput is queried. At block 302, if the network throughput is greater than 80% of the current EtherChannel maximum throughput, the availability of unused Ethernet adapters is checked at block 304. Once an unused Ethernet adapter is located, electrical power is supplied to the unused adapter using existing well known hot plug methods to power a slot associated with the unused Ethernet adapter at block 306. At this point the Ethernet interface is powered up and added to the EtherChannel group at block 308. Next at block 310, a local area network (LAN) management frame is sent to activate a switch port associated with the added Ethernet adapter. At block 312, the logic sleeps for a period of time before returning to block 300. In an exemplary embodiment, the sleep mode is about 3 seconds, however, other periods of time are contemplated suitable to the desired end purpose.

Therefore, when an Ethernet adapter is removed from the EtherChannel group, power to the removed adapter is cut off to reduce power consumption and reduce generation of thermal heat, thus increasing a potential lifespan of the plurality of adapters in the EtherChannel group.

Still referring to FIG. 3, if the network throughput is less than 50% of the current Ethernet Channel maximum throughput at block 314, an Ethernet adapter is removed from the EtherChannel group at block 316. At block 318, a LAN management frame is sent to put the switch port associated with the removed adapter into sleep mode. Then at block 320, the Ethernet interface is brought down and all system resources associated with the interface are freed. At block 322, existing hot plug methods are used to shut down the slot (e.g., power down the adapter). Next at block 312, the logic sleeps for a period of time before returning to block 300. In an exemplary embodiment, the sleep mode is about 3 seconds, however, other periods of time are contemplated suitable to the desired end purpose.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method to dynamically adjust the number of active Ethernet adapters in a EtherChannel group, the method comprising:
monitoring a total EtherChannel throughput;
determining availability of unused Ethernet adapters if the throughput is above a first predetermined throughput;
powering up and adding an unused Ethernet adapter to the EtherChannel group if the throughput is above the first predetermined throughput;
powering down and removing an active Ethernet adapter from the EtherChannel group if the throughput is less than a second predetermined throughput; and
continue monitoring the total EtherChannel throughput after sleeping for a selected period of time.

2. The method of claim 1, further comprising using a hot plug method to power up and add an unused Ethernet adapter or power down and remove an active Ethernet adapter.

3. The method of claim 2, wherein a slot associated with the unused Ethernet adapter or the active Ethernet adapter is powered on or shut down, respectively.

4. The method of claim 1, wherein the selected period of time is about three seconds.

5. The method of claim 1, wherein the first predetermined throughput is greater than 80% of a current maximum EtherChannel throughput.

6. The method of claim 1, wherein the second predetermined throughput is less than 50% of a current maximum EtherChannel throughput.

7. The method of claim 1, wherein the powering up and adding an unused Ethernet adapter to the EtherChannel group further comprises sending a LAN management frame to activate a switch port of the added adapter.

8. The method of claim 1, wherein powering down and removing an active Ethernet adapter from the EtherChannel group further comprises sending a LAN management frame to put a switch port of the removed adapter into sleep mode.

9. A method to dynamically adjust the number of active Ethernet adapters in a EtherChannel group, the method comprising:
monitoring a total EtherChannel throughput;
determining availability of unused Ethernet adapters if the throughput is greater than 80% of a current maximum EtherChannel throughput;
powering up and adding an unused Ethernet adapter to the EtherChannel group if the throughput is greater than 80% of the current maximum EtherChannel throughput;
sending a LAN management frame to activate a switch port of the added adapter;
powering down and removing an active Ethernet adapter from the EtherChannel group if the throughput is less than 50% of a current maximum EtherChannel throughput;
sending a LAN management frame to put the switch port of the removed adapter into sleep mode; and
continue monitoring the total EtherChannel throughput after sleeping for a selected period of time.

10. The method of claim 9, wherein a hot plug method is used to power up and add the unused Ethernet adapter or power down and remove the active Ethernet adapter.

11. The method of claim 9, wherein a slot associated with the unused Ethernet adapter or the active Ethernet adapter is powered on or shut down, respectively.

12. The method of claim 9, wherein the selected period of time is about three seconds.

13. A system for dynamically adjusting the number of active Ethernet adapters based on a network workload, the system comprising:
a EtherChannel group having a plurality of Ethernet drivers each associated with a corresponding Ethernet adapter; and
a network throughput monitor which tracks throughput of transmission (Tx) and reception (Rx) of the EtherChannel group including a Tx count register and Rx count register, respectively, associated with each corresponding Ethernet driver,
wherein the network monitor is configured to add or delete an active Ethernet adapter from the EtherChannel group based on a current network workload.

14. The system of claim 13, wherein the network throughput monitor is configured to:
monitor a total EtherChannel group throughput;
determine availability of unused Ethernet adapters if the throughput is above a first predetermined throughput;
power up and add an unused Ethernet adapter to the EtherChannel group if the throughput is above the first predetermined throughput;
power down and remove an active Ethernet adapter from the EtherChannel group if the throughput is less than a second predetermined throughput; and
continue to monitor the total EtherChannel throughput after sleeping for a selected period of time.

15. The system of claim 14, wherein a hot plug method is used to power up and add an unused Ethernet adapter or power down and remove an active Ethernet adapter.

16. The system of claim 15, wherein a slot associated with the unused Ethernet adapter or the active Ethernet adapter is powered on or shut down, respectively.

17. The system of claim 14, wherein the selected period of time is about three seconds.

18. The system of claim 14, wherein the first predetermined throughput is greater than 80% of a current maximum EtherChannel throughput, and the second predetermined throughput is less than 50% of a current maximum EtherChannel throughput.

19. The system of claim 14 wherein the powering up and adding an unused Ethernet adapter to the EtherChannel group includes sending a LAN management frame to activate a switch port of the added adapter.

20. The system of claim 14 wherein powering down and removing an active Ethernet adapter from the EtherChannel group includes sending a LAN management frame to put a switch port of the removed adapter into sleep mode.
